(19) United States
(12) Patent Application Publication
(10) Pub. No.: US 2014/0138418 A1
(43) Pub. Date: May 22, 2014

(54) Integrated CD Mounting Apparatus For Portable Electronic Device

(71) Applicant: Chance Dunn, Livermore, CA (US)

(72) Inventor: Chance Dunn, Livermore, CA (US)

(21) Appl. No.: 13/867,879

(22) Filed: Apr. 22, 2013

Related U.S. Application Data
(63) Continuation-in-part of application No. 11/445,120, filed on May 31, 2006, now Pat. No. 8,505,795.

(51) Int. Cl. B60R 7/06

(52) U.S. Cl. CPC B60R 7/06
USPC 224/483

(57) ABSTRACT

A personal electronic device (PED) vehicle mounting apparatus. More particularly, the present invention relates to a PED holder that couples to a vehicle's compact disc (CD) slot on a motor vehicle dash board.

### RELATED APPLICATIONS

This application is a CIP (continuation-in-part) of application Ser. No. 11/445,120, filed on May 31, 2006, having the same inventive entity, Chance Dunn, and titled: “CD MOUNTING APPARATUS FOR PORTABLE ELECTRONIC DEVICE” and is herein incorporated by reference for its supportive teachings.

### BACKGROUND OF THE INVENTION

A. Field of the Invention

The invention disclosed relates generally to a device for mounting portable electronic devices (hereinafter “PED”) to a vehicle. More particularly, the present invention relates to a mounting apparatus that holds the PED to a compact disk (“CD”) player opening located in a dash of a motor vehicle.

B. Description of the Prior Art

There exist several mounting devices for automobile electronics. Each of the following prior art patents are herein incorporated by reference for their supporting teachings. For example, Benedeti invention U.S. Pat. No. 5,813,583 provides a portable CD holder that can be screwed into the underside of the dashboard. This requires that the dashboard of the vehicle be permanently altered, along with the associated risks and expenses. The Sokol invention, U.S. Pat. No. 4,648,572, utilizes a suction cup device intended to attach to the front windshield of the vehicle to support a radar detector device. Such a device has limitations including negative aesthetic characteristics, limiting the view of the driver, and eventual loss of adhesion to the surface of the windshield.

Also, the pending application (application Ser. No. 11/387,576) of this applicant (Chance Dunn) discloses a bracket and PED holder that attaches to an audio cassette. While this invention is novel and useful, as fewer automobiles are being equipped with audio cassette players, a device that holds a PED in an automobile CD player is needed.

### SUMMARY OF THE INVENTION

Portable electronic devices (PEDs) include, but are not limited to, the following devices: mp3 players, iPods, cell phones, satellite radios, PDAs, or other digital audio sources. Given the rapid advance of portable audio technology that now includes the use of digital audio sources, many people access music via the PED in addition to, or instead of a CD player. However, most automobiles have CD players in the dashboard.

As discussed above, mounting a mobile device inside an automobile is usually Inconvenient. The limited space of the automobile is already utilized by the car stereo and other in-dash items that make the mounting of additional devices inconvenient. The invention described herein allows for the mounting of any appropriately sized electronic device in a convenient place to reach without obstructing the driver's viewing area.

The present invention includes a personal electronic device [PED] holder, designed to be mounted to a CD player slot located in a vehicle dashboard, comprising:
a) a mounter, having a generally horizontal orientation while in operation of being mounted in the CD player slot, and designed to securely mount the electronic device holder to the CD player slot, having:
   i. a first insert, having a flat upward and bottomward facing surface as oriented when placed into the CD player slot, and having a first insert edge that is first inserted into the CD player, and an attachment end that is opposite to the first insert edge, the first insert forming a first insert plane extending along the upward and bottomward facing surface;
   ii. a second insert, having a flat upward and bottomward facing surface as oriented when placed into the CD player slot, and having a second insert edge that is inserted into the CD player, and an attachment end that is opposite to the second insert edge, the second insert is sized to have a portion fit within the CD player slot, wherein only the second insert bottomward facing surface and first insert upward facing surface contact the CD player slot when placed in the CD player slot, the second insert forming a second insert plane along the upward and bottomward facing surface; and
   iii. an adjustment mechanism, having:
      a) a retainer, fixedly coupled to the first and second attachment end, having a linear width larger than the thickness and depth, wherein the thickness forms the thickness of a retainer plain extending along the linear width and depth that is substantially complainer with the first and second attachment end;
      b) a first position that retains the first and second attachment end in the retainer plain in a fixed unmoving position relative to each other, and placing the first and second insert plain relatively parallel to the retainer plain;
      c) a second position that retains the first and second attachment end in the retainer plain in a fixed unmoving position relative to each other, and simultaneously retaining a retaining angle between the first and second insert plain; and
      d) an adjuster, adjustably coupled to first insert, having a threaded outside surface, whereby turning of the adjuster causes the first insert plane to move away from the second insert plane and forming the retaining angle between the first and second insert plane;
b) a holder, rotatively attached to the mounter, and having a top surface facing that is incapable of facing the mounter and substantially forms a top surface plane, the top surface plane incapable of being oriented parallel to the retainer plane and the first and second insert plane, and incapable of being oriented facing the mounter; and
c) a securing mechanism, mounted to the top surface of the holder, designed to retain the electronic device to the holder in a generally vertical orientation to the retainer plane.

In another potential embodiment of the invention there may be a personal electronic device holder, designed to be mounted in a vehicle, comprising:
a) a mounter, having a generally horizontal orientation while in operation of being mounted in the CD player slot, having:
   i. a first insert, having a flat upward and bottomward facing surface as oriented when placed into the CD player slot, and having a first insert edge that is inserted into the CD player, and an attachment end that is opposite to the first insert edge, the first insert forming a first insert plane extending along the upward and bottomward facing surface;
   ii. a second insert, having a flat upward and bottomward facing surface as oriented when placed into the CD player slot, and having a second insert edge that is inserted into the CD player, and an attachment end that is opposite to the second insert edge, wherein the second bottomward facing surface and first plate upward facing surface contact the CD player slot when placed in the CD player slot, the second insert forming a second insert plane extending along the upward and bottomward facing surface; and
   iii. an adjustment mechanism, having:
      a) a first position that retains the first and second attachment end in a fixed unmoving position relative to each other, and placing the first and second insert plain relatively parallel to each other;
      b) a second position that retains the first and second attachment end in the retainer plain in a fixed unmoving position relative to each other, and simultaneously retaining a retaining angle between the first and second insert plain; and
      c) an adjuster, adjustably coupled to first insert, having a threaded outside surface, whereby turning of the adjuster causes the first insert plane to move away from the second insert plane and forming the retaining angle between the first and second insert plane;
b) a holder, rotatively attached to the mounter, and having a top surface that is incapable of facing toward the mounter; and
c) a securing mechanism, mounted to the top surface of the holder, designed to retain the electronic device to the coupler holder in a generally vertical orientation to the retainer plane.

In yet a further potential embodiment of the illustrated invention, there may be an electronic device holder, an electronic device having a flat back side and a flat visual display screen, and transportation vehicle, designed to carry a driver, having an interior with a dash, a steering wheel, and a windshield, comprising:
a) a mounter, coupled to one end of the electronic device holder, having a first coupling end that is removably coupled to the vehicle interior, and a second end;
b) a holder, having a holder first end that is rotatively attached to the second end of the mounter, and having a top flat surface portion, coupled to the holder first end, that is incapable of facing toward the mounter, and is incapable of contacting around circular devices circumferential surface; and
c) a securing mechanism, mounted to the top surface of the holder, having a layer of attachment material that will removably attach to the flat back side of the electronic device to hold the flat visual display screen oriented toward the steering wheel of the vehicle.

Alternatively, the portion of the device capable of insertion into the opening of the CD player may comprise two substantially parallel plates capable of separation. The plates may be separated through the use of one or more screws (or similar mechanism) in contact with the two plates. The plurality of screws may include a knob, wings, or similar device for use. Similarly, the parallel plates may include an arc shaped cutout on the front end of the leading edge. Further, the parallel plate embodiment allows the user to insert the device into the opening of the CD player, then put pressure from the top and bottom edges of the plates onto the opening of the CD player, thus causing the device to fit securely therein.

The bracket and mounting apparatus may be configured in one piece, or multiple attached pieces. The bracket portion is shaped and configured such that a CD can remain in the vehicle's CD player during use, while the bracket projects outward from the CD player. Another embodiment allows the bracket portion to retract to minimize the portion extending away from the CD player.

Some dashboard configurations would not allow for the convenient placement of this invention while the PED is placed above the plane of the wedge/bridge portion of the device. For example, a configuration where the top of the dashboard slopes forward (towards the passenger compartment) may interfere with the placement of the PED and PED holder. As such, another embodiment of this invention allows the device to be inverted. The parallel or wedge shaped plates portion will secure the device into the CD player opening equally well in the inverted position. Still another configuration allows the parallel plates or wedge to remain secured in the CD player opening while the PED holder member pivots or rotates into either the above plane (or below plane) configuration.

The present invention includes a bracket that is attached to the parallel plate shaped member. The bracket is shaped and configured such that the device may remain attached to the vehicle's CD player during use, while the bracket projects outward from the CD player. At the other end of the bracket is a means to hold a PED. In one embodiment, the means to hold the PED comprises a clip or basket or similar arrangement that holds the PED during use. Another embodiment comprises a relatively flat surface of the bracket portion facing the driver that can include a Velcro or sticky, tacky or releasable adhesive substance. Using this configuration, these substances may then be placed on the back of the PED, or only just on the holding plate for the bracket. These configurations will allow the user to easily secure the PED to the device. The above described device and configuration allows the user to easily, safely, and conveniently access their PED while in their automobile.

Reference throughout this specification to features, advantages, or similar language does not imply that all of the features advantages that may be realized with the present invention should be or are in any single embodiment or the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

### BRIEF DESCRIPTION OF THE DRAWINGS

In order for the advantages of the invention to be readily understood, a more particular description of the invention briefly described above will be rendered by reference to specific embodiments that are illustrated in the appended drawings. It is to be understood that these drawings depict only typical embodiments of the invention and are not therefore to be considered to be limiting of its scope, the invention will be described and explained with additional specificity and detail through the use of the accompanying drawings.

FIG. 1 is a perspective view of an embodiment of the invention.

FIG. 2 is a cross-section side view of an embodiment of the invention.

FIG. 3 is a top-down view of a portion of an embodiment of the invention.

FIG. 4 is a perspective view of an embodiment of the invention installed in the opening of a dash mounted CD player.

FIG. 5 is a perspective view of an embodiment of the invention installed in the opening of a dash mounted CD player.

FIG. 6 is a perspective view of an embodiment of the invention.

FIG. 7 is a cross-section side view of an embodiment of the invention.

FIG. 8 is an isometric exploded perspective rear view of another embodiment of the invention.

FIG. 9 is an isometric rear perspective view of the embodiment of the invention in FIG. 8.

FIG. 10 is a straight on rear view of the embodiment of the invention in FIG. 8.

FIG. 11 is a straight on front view of the embodiment of the invention in FIG. 8.

FIG. 12 is a straight on top view of the embodiment of the invention in FIG. 8.

FIG. 13 is a straight on bottom view of the embodiment of the invention in FIG. 8.

FIG. 14 is an isometric perspective view of the embodiment of the invention in FIG. 8 as mounted in a CD player slot that is mounted in a dash of a vehicle while holding a PED therein.

FIG. 15 is a side view of the embodiment of the invention in FIG. 8 as mounted in a CD player slot that is mounted in a dash of a vehicle.

FIG. 16 is a sectional view of one embodiment of internal operations of components.

FIG. 17 is another side view of one embodiment of the device before actuation of the separation of the CD slot inserted center, right and left plates.

### DETAILED DESCRIPTION OF THE DRAWINGS

For the purposes of promoting an understanding of the principles of the invention, reference will now be made to the exemplary embodiment. Wherein, each statement of an embodiment is to be considered independent or any other embodiment, despite any use of similar or identical language.

Reference throughout this specification to “one embodiment,” “an embodiment,” or similar language means that a particular feature, structure, or characteristic described in connection with the embodiment is included in at least one embodiment of the present invention.

Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

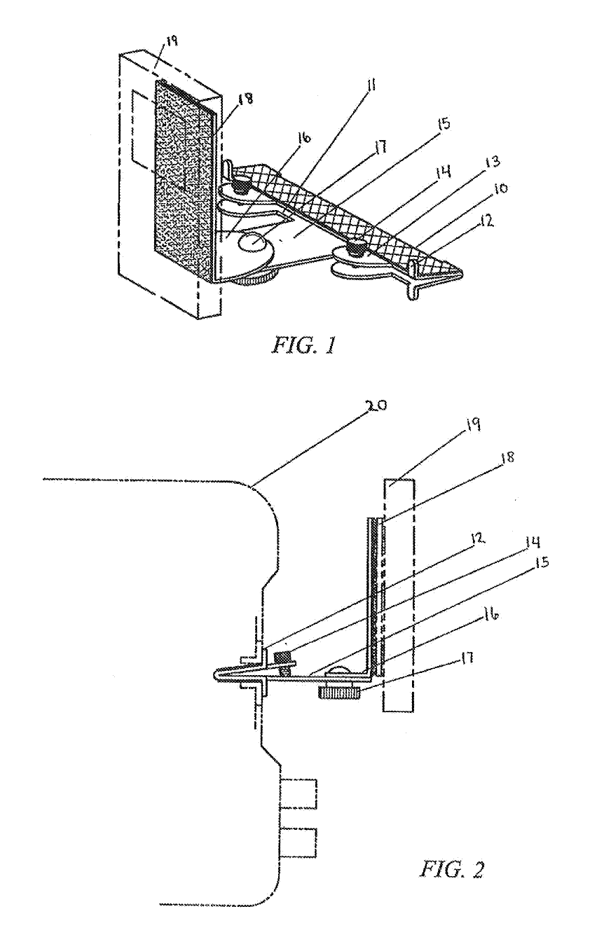

FIG. 1 is a perspective view of an embodiment of the invention. The wedge shaped CD player insert is shown, as well as the attached stoppers 12 on the ends of the wedge. These stoppers act as a guide when placing the device into the CD player opening and limit bow far the wedge portion can be inserted into the CD player opening. As the top and bottom portions of the wedge are separated, the angle of the wedge becomes steeper. If this separation takes place while the wedge is inserted into the CD player opening, additional pressure will be placed by the wedge into the opening, which will aid in stabilizing the device during use. Wedge flaps. 13 are shown at the rear end of the wedge member. The wedge flaps 13 can be attached to, or made part of the wedge member. The top and bottom flaps can be separated from each other via a variety of means, including but not limited to, screws, springs, memory foam, etc. In FIG. 1, the embodiment show that the wedge is separated by a wedge flap screw 14 that is located in each of the wedge flaps 13. A bracket 15 (or bridge) member projects from the lower wedge 11. However, certain embodiments allow some or all of the device to be rotated such that the PED is located substantially below the plane of the protruding bracket FIG. 1 illustrates an embodiment where the CD player insert is attached to a bridge bracket 15 that extends out from the lower wedge portion of the insert 11, such that the bracket15 extends out from the insert when the insert 11 is placed in the CD player of the automobile.

The bracket 15 may be made from a variety of different materials, including but not limited to metal and/or plastic. In one embodiment, the bracket 15 is rigid, while in other embodiments the bracket 15 is flexible. The bracket 15 can be affixed to the insert in a variety of ways, including the use of adhesive, or a mechanical attachment, such as with a physical coupling the insert and bracket. The bracket 15 can also be integrated into the insert such that it comprises an extension 10 of the CD insert, and can be made from the same material as the CD insert. The bracket 15 is configured such as to allow it to extend from the CD insert while it is engaged in the opening of the CD player.

A mounting apparatus 16 is shown attached to the bracket 15 via a connecting bracket screw 17. This arrangement allows the mounting apparatus 16 (and PED when mounted) to swivel to a convenient position.

FIG. 1 also shows a holding plate 18 attached to the end of the mounting apparatus 16. In one embodiment, this holding plate 18 can comprise a relatively flat rigid surface with a Velcro (or the like) surface facing outward from the CD player. If the user places Velcro or the like on the back of their PED 19, this configuration would allow the user to easily affix their PED 19 onto the holding plate 18, as well as easily remove it In other configurations, such as in FIG. 5, the user can place the PED 19 within a clip apparatus, located at the end of the mounting apparatus 16, that supports the PED 19 from both sides and the bottom. In a preferred embodiment the clip apparatus will allow the PED 19 to remain open and unfettered on top, which will allow the user to easily access the headphone jack of the PED 19, which is typically located on top of the PED 19.

FIG. 2 is a cross-section side view of an embodiment of the invention. It shows an embodiment of the invention installed in the dashboard 20 of a vehicle. After insertion of the wedge portion into the opening of the CD player, the stoppers 12 abut the exterior surface of the CD player. These stoppers 12 control the depth of the wedge portion into the CD player. When the wedge flap screw 14 is engaged, this separates the wedge and puts pressure on the interior of the CD player opening, thus firmly holding the device in place.

FIG. 2 also illustrates the bracket screw 17, which connects the bracket IS and the mounting apparatus 16. This connection also allows the mounting apparatus 16 to rotate to into a 15 position suitable to. the user. As in FIG. 1, the holding plate 18 is attached to the end of the mounting apparatus 16. In this embodiment, the holding plate 18 can comprise a relatively flat rigid surface with a Velcro (or the like) surface facing outward from the CD player. A Velcro or similar type material is shown on the forward facing portion of the holding plate 18. The figure shows a similarly sized strip of Velcro or similar type material on the back of the PEP 19. This configuration allows the user to simply press the PED 19 against the holding plate to secure it In this embodiment, the CD player is located in the dashboard of an automobile. After the PED 19 has been secured to the apparatus in this fashion, the PED 19 will be can be easily accessed by a user located in the front seat of the automobile.

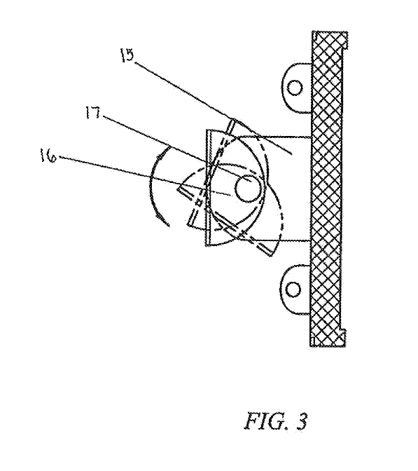

FIG. 3 is a top-down view of a portion of an embodiment of the invention. This drawing illustrates a feature of certain embodiments that allow the device to rotate about the bracket screw 17. By loosening the bracket screw 17, the mounting apparatus 16 (along with the PED) can be swiveled into the desired position. When the mounting apparatus 16 is in the desired position, the bracket screw 17 can be tightened to lock the mounting apparatus 16 in 10 place. During this process, the bracket 15 remains stationary.

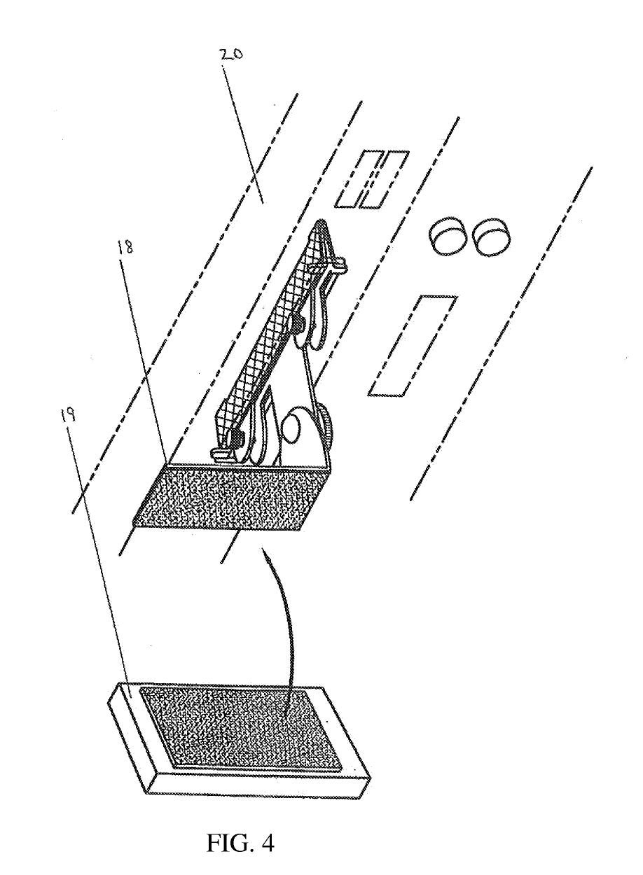

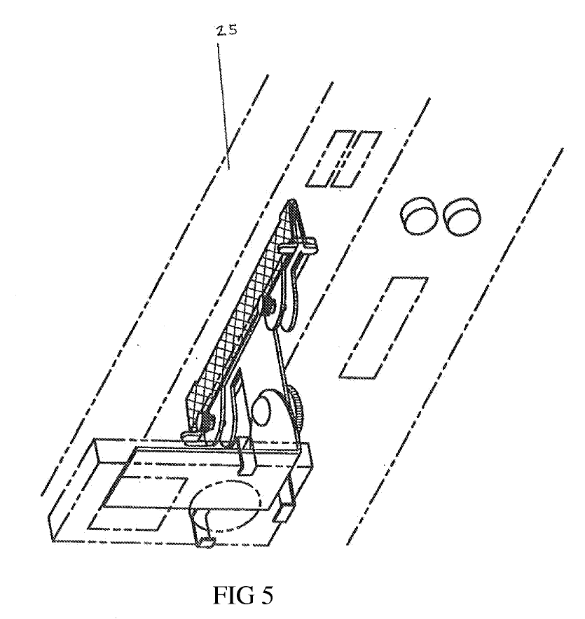

FIG. 4 is a perspective view of an embodiment of the invention installed in the opening of a dash mounted CD player. This figure illustrates an embodiment utilizing the holding plate18 at the end of the bracket 16. The PED 19 has not yet been affixed to the holding plate 18. A Velcro or similar type material is shown on the forward facing portion of the holding plate 18. The figure shows a similarly sized strip of Velcro or similar type material on the back of the PED19. This configuration allows the user to simply press the PED 19 against the holding plate to secure it in this embodiment, the CD player is located in the dashboard of an automobile. After the PED 19 has been secured to the apparatus in this fashion, the PED 19 can be easily accessed by a user located in the front seat of the automobile.

FIG. 5 illustrates an embodiment utilizing a clip 21 (or basket) arrangement for holding the PED 19. In the embodiment shown, clips 21 extend from the two sides and the bottom of the holding plate 18, on the side of the holding plate farthest: from the CD player. In the configuration shown, the ends of the clips 11 located on the sides of the holding plate are angled at approximately 90 degrees from the portion of the clip extending from the holding plate, this bend in the clip angling towards the middle of the holding plate 17. Similarly, the clip 21 supporting the bottom of the PED 19 is angled up at the end. These bends in the clips 21 assist in seeming the PED 19 when placed within the confines of the apparatus. Alternative embodiments include a basket arrangement on the end of the bracket 15 capable of supporting and seeming a PED 19. Such an embodiment is preferably open on top to 10 facilitate easy placement and removal of the PED 19, as well as facilitate easy plugging in and unplugging of the PED 19 headphones.

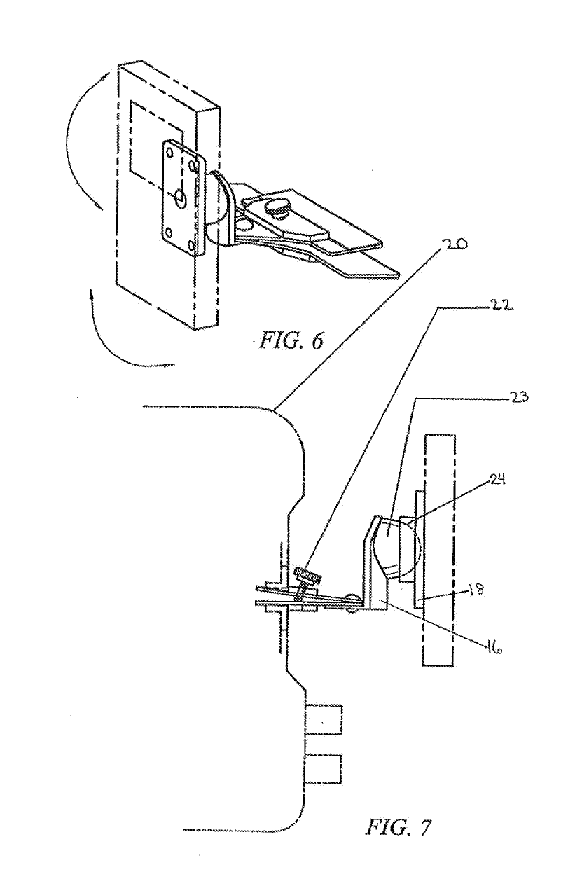

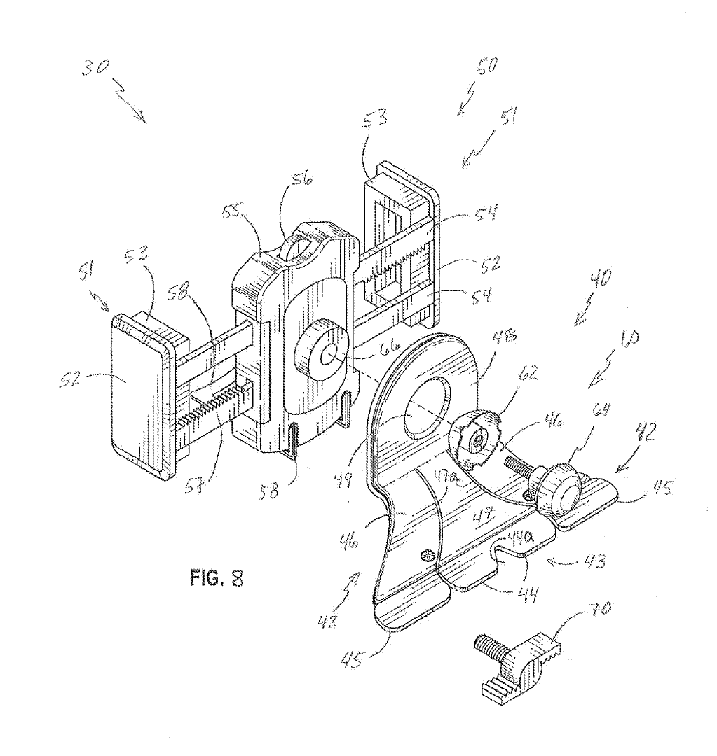

FIGS. 6 and 7 are perspective views of an embodiment of the invention. These illustrations shows a configuration that utilizes one separation screw 22 with a knob located above the top wedge, with the screw penetrating the top portion of the wedge and abutting the 15 lower wedge-portion. As the screw 22 is tightened, the wedge portions are separated, thus seeming the device by creating pressure between the wedge and the opening to the CD player. so shown in FIGS. 6 and 7 is an embodiment utilizing a ball 23 and socket joint 24. The ball 23 is shown attached to the mounting apparatus 16 and the socket joint 24. The socket joint 24 may be permanently attached to the holding plate 18, or basket, or clip arrangement. It is 20 intended that the connection between the ball 23 and the mounting apparatus 16 be fixed and stationary, while the connection between the ball 23 and the socket joint 24 can be accomplished through the use of a screw, or other similar mechanism. Similarly, a clip 21 {or basket) device can easily be substituted for the holding plate 18 shown in FIGS. 6 and 7. In a preferred embodiment, the ball 23 remains stationary relative to the mounting apparatus 16, while the socket joint is allowed to swivel relative to the ball 23. This will allow the user to adjust the vertical and/or horizontal angle of the PED 19 when attached to the apparatus. This embodiment also allows the• user to remove and rotate the device 180 degrees, and re-insert the device into the CD player opening. This may be a preferred embodiment if the user's dashboard 20 is shaped in a way that interferes with the use of the apparatus when in the 10 upright position shown in FIGS. 6 and 7.

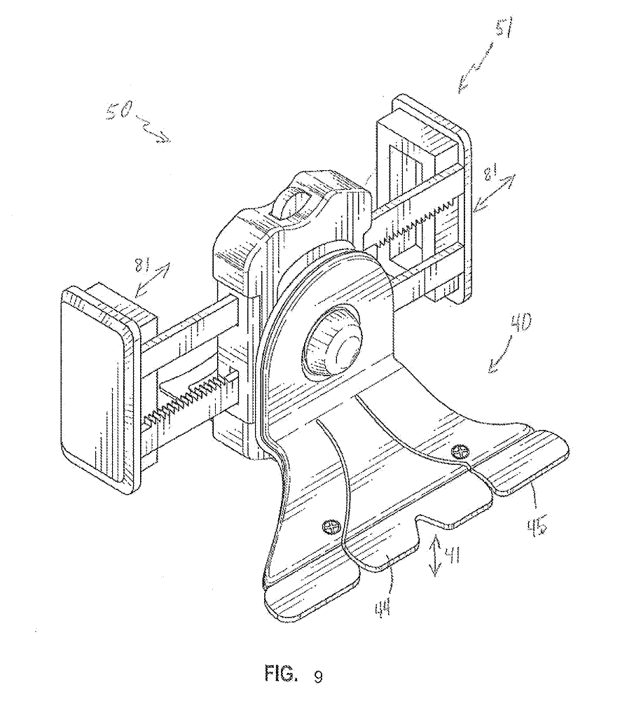

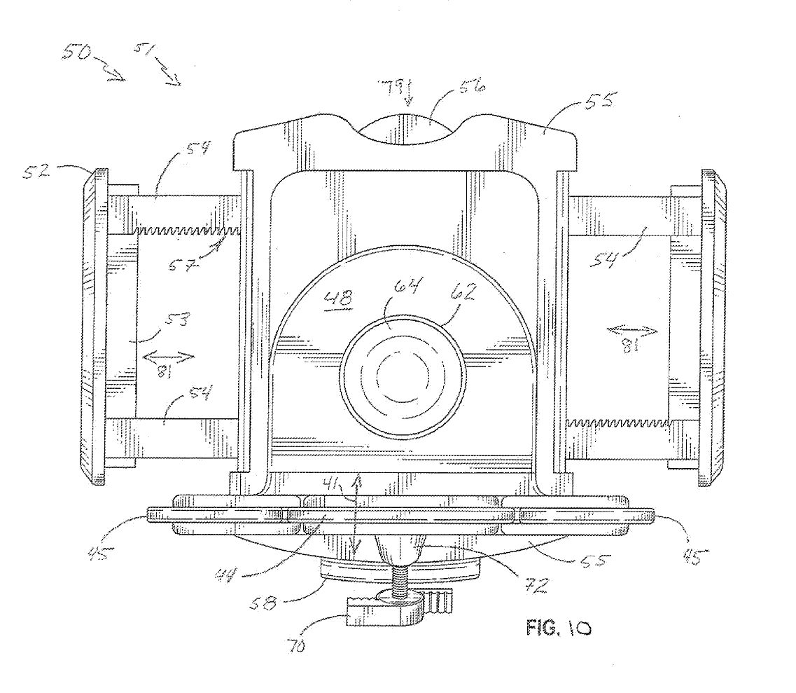

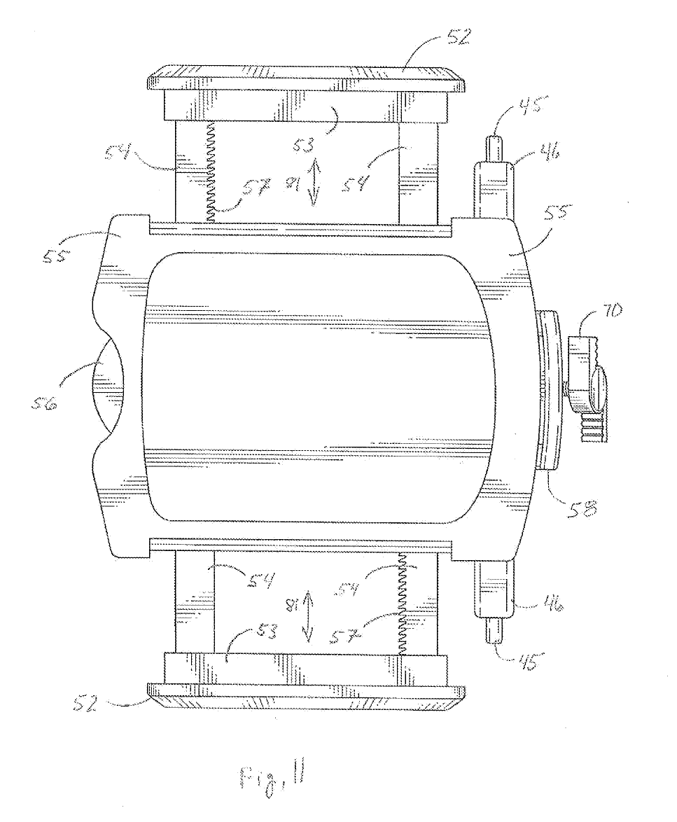

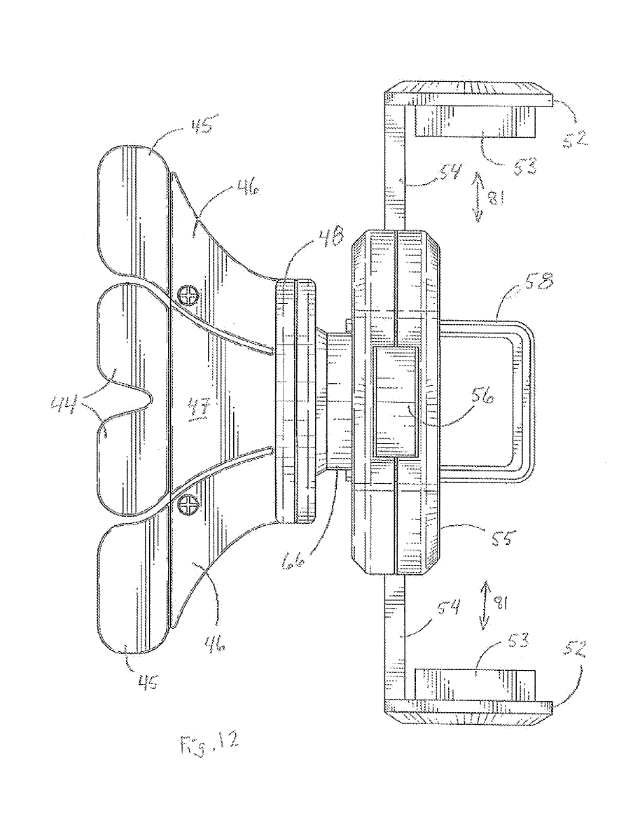

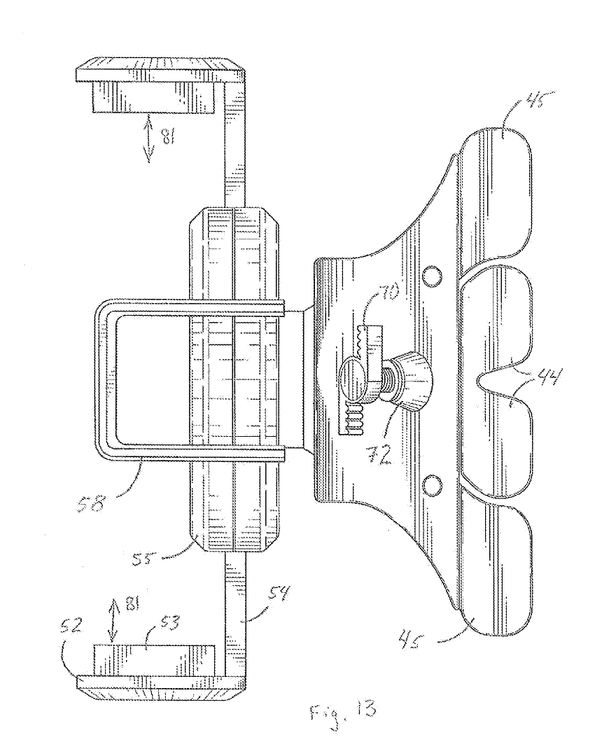

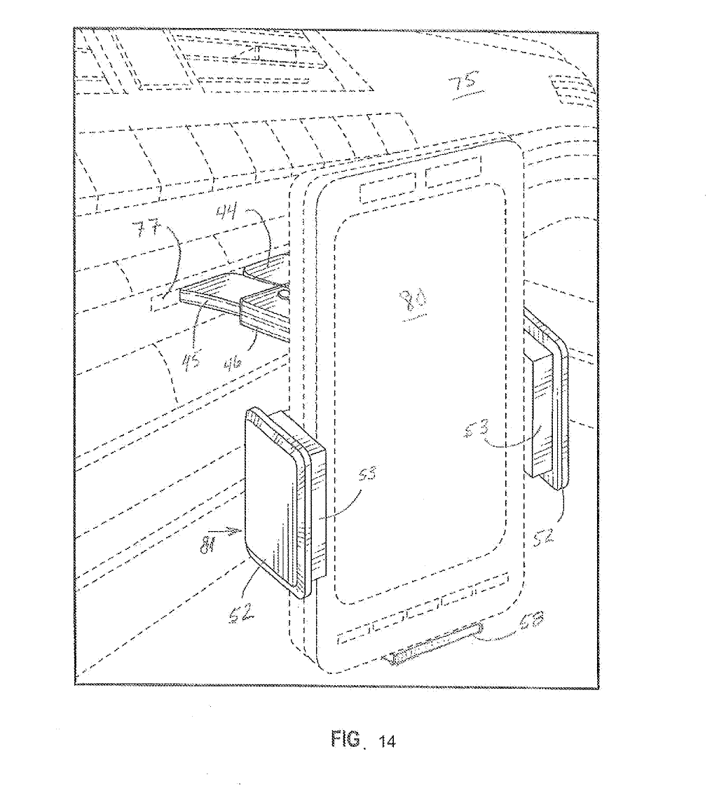

Referring to all of the remaining FIGS. 8-15, there is illustrated another embodiment of the invention 50 as is also intended to be mounted in a CD player slot 77 that is mounted in a dash of a vehicle 75. Specifically, there is illustrated a PED holder 50, comprising a CD slot mounting bracket 40 and a PED 80 holding mechanism 51. The mounting bracket 40 includes insert portion 42, illustrated as three plates, protrusions or tangs, a left and right plate/tang 45, and a center plate/tang 43, which is made of two connected flat sections 44 with a V-shaped notch 44a separating the two equal flat sections 44. These insert portions 43 and 45 are coupled to connecting portions 46 and 47 respectively as illustrated, which in turn are coupled to mounting plate 48. It is noted that connecting portions and mounting plate 48 are formed of a single interconnected material, and that the center connecting portion 47 is partially separated therefrom by slots 47a to allow form a move upward and downward relative to the other two connection portions 46 and plated 45 that are positioned on either side as illustrated. Mounting plate 48 includes a hole 49, which is designed to contain mounting mechanism 60. The mounting mechanism 60 includes a spacer 62 and a threaded screw article 64 for threadably securing the CD slot-mounting bracket 40 to the PED holding mechanism 51 by threadably being mounted to threadable receptacle 66 in known engineering fashion. PED holding mechanism or assemblage 51 includes two opposite clamping plates 52, two clamping holding pads 53 mounted on each clamping plate 52 to face each other as illustrated, at least two connecting portions 54 coupled to the clamping plates 52 respectively as illustrated, at least one set of teeth 57 mounted to at least one of the connecting portions 54, a housing 55 to house an adjusting mechanism 56 that holds the plates 52 in the selected position by allowing the teeth 57 and connection portions 54 to slide into the housing 55. Additionally, there is a resting plate 58 that is positioned at a bottom of the housing 55, and is designed to rest a bottom portion of a cell phone or personal electronic device (PED) 80 thereon. Whereby, the adjusting mechanism 56 will hold, by way of the teeth 57, the plates 52, pads 53, and connecting portions 54 in place as the assemblage 51 is moved 81 by a user into a closed position to hold and engage outer edges of the cell phone or PED 80 by the pads 53 as illustrated in FIG. 14.

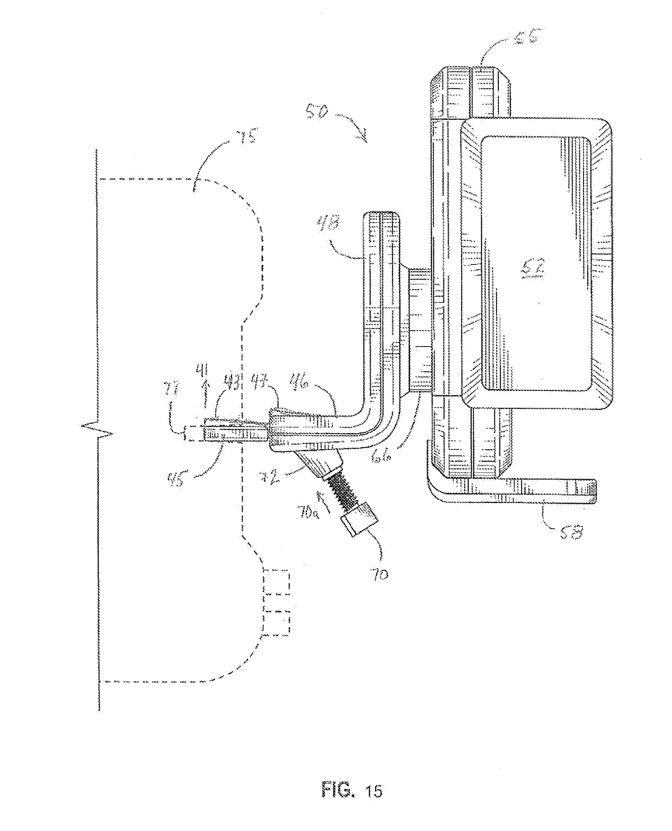

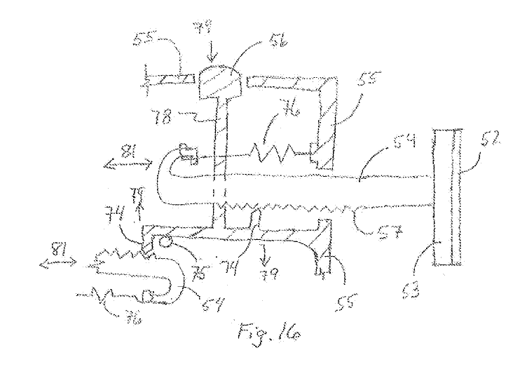

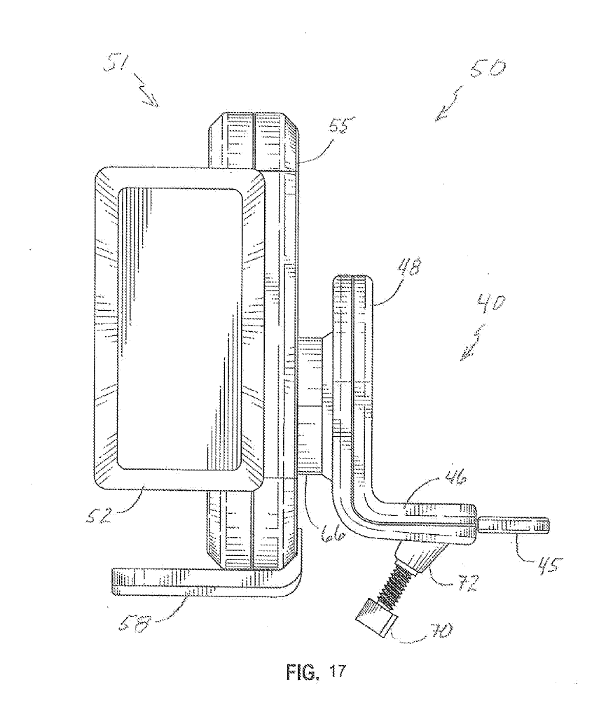

Referring to FIGS. 15 and 17 more specifically, there is illustrated one embodiment of an operation of the device 50 as it is forcibly held within the CD slot 77, which is mounted to the dash 75 of a vehicle. Wherein, FIG. 17 illustrates the device 50 before the center plate 43 is moved into its locking position with its larger cross-sectional profile that extends above the plane of the left and right plates 45, which in turn wedges into the CD slot 77. In particular, FIG. 15 illustrates that once the center 43, right, and left plates 45 are inserted into the slot 77, an adjustment mechanism 70, illustrated in the form of a screw, may be tightened inward 70a within the threaded housing 72 to force an upward displacement 41 of the center plate 43 and integrally connected center connecting portion 47 relative to the non-moving right and left plates 45 and their integrally connected outer connection portions 46. It is this displacement from the originating planer orientation that was in common to each of the three plates 43 and 45, which causes the opening or expansion of the vertical profile of the three plates, and thus will cause the upper side of the center plate 43 to be forcibly pushed against the upper side of the CD slot 77, and the lower side of the right and left plates 45 to contact the lower sections of the CD slot 77; thus, creating a wedging or frictional fitting therein sufficient to hold the device 50 in its intended orientation as illustrated in FIG. 14. It is noted that the connecting portions 46 and 47 are made of sufficient elastic material to allow for the needed relative movement therebetween, yet rigid enough to allow the center plate 43 to realign with its companion side plates 45 once the adjustment mechanism 70 is reversed and no longer exerts a force against the center plate 43. Thus allowing the center plate 43 to be inline with the other plates 45 and eliminating the thicker side profile created therefrom, which will allow for the easy removal of the mounting bracket 40 from the CD slot 77.

Referring to FIG. 16, there is an illustration of a sectional portion of one potential embodiment to effectuate the operations of the device 50 to hold and release a PED 80 therein. Specifically, there may be a teeth engagement device 74 as illustrated, positioned to forcibly upwardly engage against the valleys of the teeth and thus prevent unwanted movement of the connecting portion 54. To achieve movement 81 thereof, a user exerts sufficient force against the plates 52 toward the housing 55 to move the plates 52 and pads 53 toward the housing 55 in a known fashion. A biasing device, or spring 76 may be coupled and positioned to bias the connecting portions 54 in an outward fashion, or in a direction to force the plate 52 away from the housing 55. There may also be a pivot portion 75 fixedly positioned appropriately next to one part of the linkage 78 to cause the engagement device 74 to move upward when the adjustment mechanism 56 is moved downward 79. Additionally, the linkage 78 is linked to the adjustment mechanism 56 to the teeth engagement device 74, to allow a user to actuate a downward movement 79, and thus causing the engagement device 74 to disengage both downward and upward from the respective illustrated teeth 57, which enables the biasing devices 76 to force the respective connection portions 54 and plates 52 away from the housing 55, thereby releasing any cell phone or PED 80 from the gripping effect of the pads 53. Pads 53 may be made of a soft material that will conform around the surface of a PED 80 in a know fashion (not illustrated). One skilled in the mechanical arts will easily understand the operation of this illustrated embodiment, and know how to effectuate the opposite operation in closing the device 50 around a PED 80, whereby a user moves the plates 52 toward the housing 55 to tightly and frictionally hold the PED 80 therebetween the pads 53 as illustrated in FIG. 14.

It is noted that the insert plates 43 and 45 have a certain width profile that is approximate to the width and thickness of a known CD (compact disc), and that only the center plate 43 is elevated, while the side plates 45 are maintained in the original plane or orientation that is similar to a CD that would be placed into the CD slot 77. First, this width dimension is selected to add stability to the device 50 as it is mounted within the CD slot 77. In particular, if the width were any smaller, there would be a chance for the device 50 to rock from side to side while being bounced and jarred during the operation of the vehicle along rough roads. This width especially prevents the potential wobble of the cell phone or PED 80, which could launch the PED 80 at the driver unexpectedly in a worse case scenario. Second, the right and left plate 45 common plane orientation with the typically inserted CD is selected to keep the device 50 in a level to the CD slot orientation and to prevent the device 50 from being cockeyed, or off kilter, if one side had been moved or displaced as is center plate 43, ie. the left side could be higher than the right side, and cause the tilt of the devise 50 thereof.

Although the various illustration and accompanied language have depicted certain embodiments in various fashion, one skilled in the mechanical arts will understand that there are many methods and designs that may accomplish the desires of the intended invention. In particular, there are many ways to accomplish the movement 81 and holding of the two plates 52 in the desired position. For example, there is illustrated the use of two sets of teeth 57, and four connection portions 54; wherein only one set of teeth and two connection portions 54 may be used. It is even contemplated to use no teeth at all, and just have a frictional contact in place of the engagement device 74, whereby engagement device 74 would rub sufficiently hard onto the connection portions 54 as to be held in place unless a user pushes against the plates 52, and the now frictionally engagement device 74 may be disengaged in the same fashion to allow the biasing device 76 to move the plates 52 outward again.

Additionally, although the positioning of the adjustment mechanism 56 is illustrated to be located on a central top region, one skilled in the mechanical arts will know that the position may be located most anywhere on the housing. For example, the adjustment mechanism 56 may be located on the side, or bottom of the housing, just so it functions to release the holding of the side plates 52 in the desired position.

Further, one skilled in the mechanical arts will know that there are many configurations for the side plates 52. For example, the side plates 52 may not be actual plates and may be most any configuration like ovals, v-shaped or any other configuration that allows for a sufficient contact with a cell phone or PED 80 to be held therebetween like in a vice grip.

Additionally, although the word “plate” has been used herein in reference to the center plate 43, right and left 45 plates, the term is not to be considered limiting as to the dimensions and physical shape of the device such as a round dinner plate shape. Specifically, what is intended is there is a planer characteristic in the orientation of the device. For this reason, terms such as “tang” and “protrusions” and “insert” were written thereafter when the terms were first used or are used in the claims appended hereafter. However, for ease of writing, the term “plate” was carried therethrough the remainder of the specification.

The present disclosure should not be construed in any limited sense other than• that limited by the scope of the claims having regard to the teachings herein and the prior art being apparent with the preferred form of the invention disclosed herein and which reveals details of structure of a preferred form necessary for a better understanding of the invention and may be subject to change by skilled persons within the scope of the invention without departing from the concept thereof.

What is desired to be claimed as Letters Patent under the United States Constitution, Article 1, section 8, clause 8, “To promote the progress of the science and useful arts, by securing for limited times to authors and inventors the exclusive right to their respective writings and discoveries”, is set forth hereinafter, and claimed as:

1. A personal electronic device [PED] holder, designed to be mounted to a CD player slot located in a vehicle dashboard, comprising:
b) a mounter, having a generally horizontal orientation while in operation of being mounted in the CD player slot, and designed to securely mount the electronic device holder to the CD player slot, having:
i. a first insert, having a flat upward and bottomward facing surface as oriented when placed into the CD player slot, and having a first insert edge that is first inserted into the CD player, and an attachment end that is opposite to the first insert edge, the first insert forming a first insert plane extending along the upward and bottomward facing surface;
ii. a second insert, having a flat upward and bottomward facing surface as oriented when placed into the CD player slot, and having a second insert edge that is inserted into the CD player, and an attachment end that is opposite to the second insert edge, the second insert is sized to have a portion fit within the CD player slot, wherein only the second insert bottomward facing surface and first insert upward facing surface contact the CD player slot when placed in the CD player slot, the second insert forming a second insert plane along the upward and bottomward facing surface; and
iii. an adjustment mechanism, having:
e) a retainer, fixedly coupled to the first and second attachment end, having a linear width larger than the thickness and depth, wherein the thickness forms the thickness of a retainer plain extending along the linear width and depth that is substantially complainer with the first and second attachment end;
f) a first position that retains the first and second attachment end in the retainer plain in a fixed unmoving position relative to each other, and placing the first and second insert plain relatively parallel to the retainer plain;
g) a second position that retains the first and second attachment end in the retainer plain in a fixed unmoving position relative to each other, and simultaneously retaining a retaining angle between the first and second insert plain; and
h) an adjuster, adjustably coupled to first insert, having a threaded outside surface, whereby turning of the adjuster causes the first insert plane to move away from the second insert plane and forming the retaining angle between the first and second insert plane;
b) a holder, rotatively attached to the mounter, and having a top surface facing that is incapable of facing the mounter and substantially forms a top surface plane, the top surface plane incapable of being oriented parallel to the retainer plane and the first and second insert plane, and incapable of being oriented facing the mounter; and
c) a securing mechanism, mounted to the top surface of the holder, designed to retain the electronic device to the holder in a generally vertical orientation to the retainer plane.

2. A personal electronic device holder, designed to be mounted in a vehicle, comprising:
b) a mounter, having a generally horizontal orientation while in operation of being mounted in the CD player slot, having:
i. a first insert, having a flat upward and bottomward facing surface as oriented when placed into the CD player slot, and having a first insert edge that is inserted into the CD player, and an attachment end that is opposite to the first insert edge, the first insert forming a first insert plane extending along the upward and bottomward facing surface;
ii. a second insert, having a flat upward and bottomward facing surface as oriented when placed into the CD player slot, and having a second insert edge that is inserted into the CD player, and an attachment end that is opposite to the second insert edge, wherein the second bottomward facing surface and first plate upward facing surface contact the CD player slot when placed in the CD player slot, the second insert forming a second insert plane extending along the upward and bottomward facing surface; and
iii. an adjustment mechanism, having:
d) a first position that retains the first and second attachment end in a fixed unmoving position relative to each other, and placing the first and second insert plain relatively parallel to each other;
e) a second position that retains the first and second attachment end in the retainer plain in a fixed unmoving position relative to each other, and simultaneously retaining a retaining angle between the first and second insert plain; and
f) an adjuster, adjustably coupled to first insert, having a threaded outside surface, whereby turning of the adjuster causes the first insert plane to move away from the second insert plane and forming the retaining angle between the first and second insert plane;
b) a holder, rotatively attached to the mounter, and having a top surface that is incapable of facing toward the mounter; and
c) a securing mechanism, mounted to the top surface of the holder, designed to retain the electronic device to the coupler holder in a generally vertical orientation to the retainer plane.

3. An electronic device holder, an electronic device having a flat back side and a flat visual display screen, and transportation vehicle, designed to carry a driver, having an interior with a dash, a steering wheel, and a windshield, comprising:
d) a mounter, coupled to one end of the electronic device holder, having a first coupling end that is removably coupled to the vehicle interior, and a second end;
e) a holder, having a holder first end that is rotatively attached to the second end of the mounter, and having a top flat surface portion, coupled to the holder first end, that is incapable of facing toward the mounter, and is incapable of contacting around circular devices circumferential surface; and
f) a securing mechanism, mounted to the top surface of the holder, having a layer of attachment material that will removably attach to the flat back side of the electronic device to hold the flat visual display screen oriented toward the steering wheel of the vehicle.

4. The device of claim 1, wherein the mounter is attached to the dash of the vehicle.

5. The device of claim 2, wherein the mounter is attached to the dash of the vehicle.

6. The device of claim 3, wherein the mounter is attached to the dash of the vehicle.

7. The device of claim 4, wherein the mounter is attached to the dash of the vehicle.
